(19) United States
(12) Patent Application Publication
(10) Pub. No.: US 2016/0071172 A1
(43) Pub. Date: Mar. 10, 2016

(54) SYSTEM AND METHOD FOR LOCATION-AWARE PARKING EXPIRATION REMINDER AND REMOTE PARKING METER REFILL

(71) Applicant: Pitney Bowes Inc., Danbury, CT (US)

(72) Inventor: ZHENNING SHANGGUAN, Stamford, CT (US)

(73) Assignee: Pitney Bowes Inc., Danbury, CT (US)

(21) Appl. No.: 14/476,826

(22) Filed: Sep. 4, 2014

(51) Int. Cl. G06Q 30/02; H04W 68/00; H04W 4/02

(52) U.S. Cl. CPC G06Q 30/0284; H04W 4/02; H04W 68/005

(57) ABSTRACT

Methods and systems that provide parking meter expiration reminders based on location and distance of the driver from the vehicle are provided. The location, parking start time, and purchased parking duration of a vehicle are recorded using a smart device application to scan information printed on the parking meter card. The driver's location is tracked while he is away from the parking lot, and reminders are sent to the driver's smart device, based on the remaining parking duration and locate of the driver, that provide sufficient time for the driver to return to the vehicle from his current location before the parking meter card expires. Additionally, the driver can use a mobile payment option to extend the amount of purchased parking, thereby allowing the driver more time to return to the vehicle before the parking meter card expires.

### FIELD OF THE INVENTION

The invention disclosed herein relates generally to location-based services, and more particularly to a location-aware parking expiration reminder and remote parking meter refill.

### BACKGROUND OF THE INVENTION

In many urban and suburban shopping districts, metered parking lots are provided for customers to use while shopping. There are different types of metered parking systems, including a single-space coin operated parking meter, and a multi-space parking meter. In the latter, the user pre-pays at a kiosk for a desired amount of time, and the kiosk prints a parking meter card which must be displayed on the dashboard of the vehicle. The parking meter card displays the information necessary for parking enforcement officers to determine if the vehicle is legally parked, i.e., the amount of time purchased has not expired. A problem with such parking systems is that the driver must accurately estimate the duration of his activities to ensure that he will be able to return to the vehicle before the expiration of the parking meter card. In addition, existing systems dc not support remote refilling of the parking meter card, therefore requiring that driver must ensure that sufficient time remains on the parking meter card for him to return to the vehicle from his current location to perform a refill operation.

### SUMMARY OF THE INVENTION

The present invention alleviates the problems described above and provides methods and systems that provide parking meter expiration reminders based on location and distance of the driver from the vehicle. The location, parking start time, and purchased parking duration of a vehicle are recorded using a smart device application to scan information printed on the parking meter card. The driver's location is tracked while he is away from the parking lot, and reminders are sent to the driver's smart device, based on the remaining parking duration and location of the driver, that provide sufficient time for the driver to return to the vehicle from his current location before the parking meter cam expires. Additionally, the driver can use a mobile payment option to extend the amount of purchased parking, thereby allowing the driver more time to return to the vehicle before the parking meter card expires.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like of corresponding parts.

FIG. 1 illustrates in block diagram form a system according to an embodiment of the present invention;

FIG. 2 illustrates the processing flow of the system of FIG. 1 according to an embodiment of the present invention,

FIG. 3 illustrates in flow diagram form the processing performed to determine when a user should be notified to avoid expiration of a parking meter card according to an embodiment of the present invention; and

FIG. 4 illustrates an example of an isochrone polygon generated according to an embodiment of the present invention.

### DETAILED DESCRIPTION OF THE PRESENT INVENTION

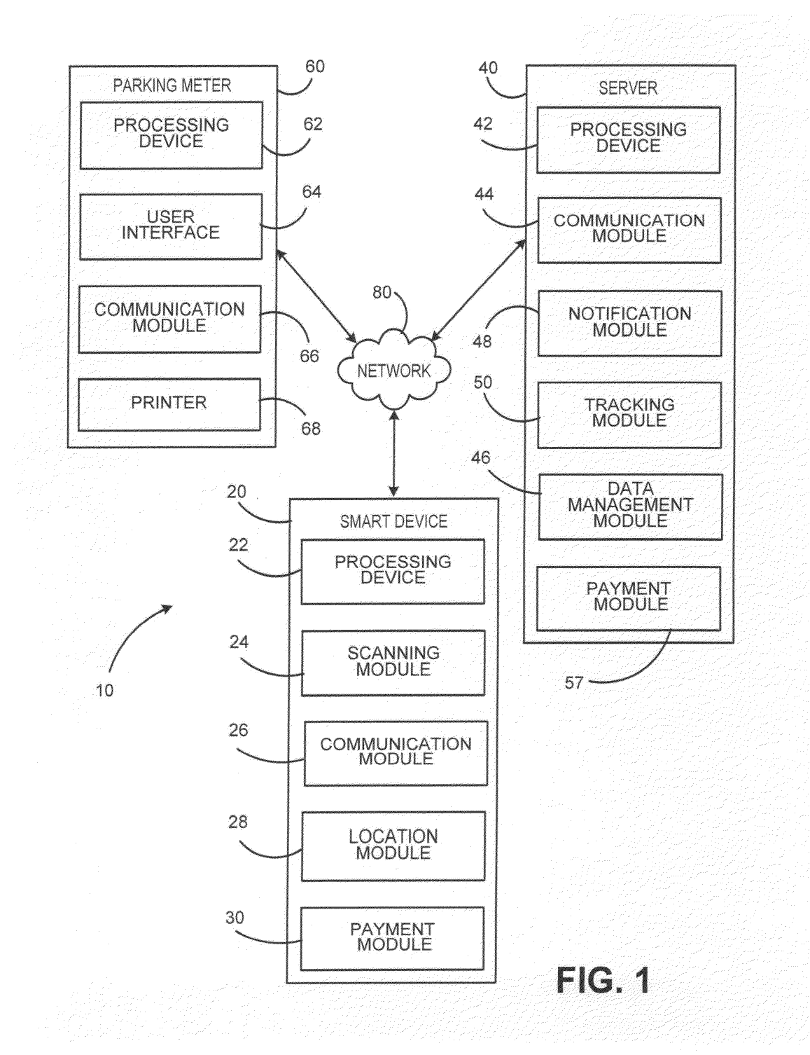

In describing the present invention, reference is made to the drawings, wherein there is seen in FIG. 1 a block diagram of a system 10 according to an embodiment of the present invention. The system 10 involves three major components: a smart device 20, a server 40, and a parking meter 60. Each of these includes several different hardware and/or software modules that operate to fulfill specific functionality, as described further below, and is configured to be able to communicate with other devices via a network 80. Network 80 may be, for example, a wireless cellular communication network.

Smart device 20 can be any type of smart device, e.g. smart-phone, tablet, personal data assistant, or any other type of electronic device that has network capability and can allow a user to access the network 80 to send and receive data from any other device capable of accessing the network 80. One of ordinary skill in the art would be familiar with the general components of a smart device upon which the present invention may be performed, and a detailed description need not be provided. Generally, device 20 includes a processing device 22 that controls the operation of the device 20. A scanning module 24 is responsible for reading information embedded in a scannable bar code printed on a parking meter card, which is generated by the parking meter machine 60. A communication module 28 provides communication services to allow the device 20 to communicate with other devices via the network 80. More specifically, it hardies outgoing traffic to the server 40 in the following cases: (1) location updates, and (2) payment data. Incoming traffic from the server 40 happens in three cases: (1) parking expiration reminder notifications, and (2) data about current parking (e.g., parking spot number, start and end time of parking duration) after the initial scan. A location module 28 provides continuous tracking of the user's location. Preferably, if is implemented as a long-running background thread and relies on underlying operating systems (i.e., Android, iOS, Windows, and etc.) to provide location updates when significant physical location changes are detected. A payment module 30 collects payment information, e.g., credit card, CCV code, etc., when the user desires to recharge a parking meter card to extend the parking duration, and secures the information for delivery to the server 40 via the communication module 26.

The server 40 may be a mainframe or the like that includes at least one processing device 42. Server 40 may be specially constructed for the required purposes, or it may comprise a general purpose computer selectively activated or reconfigured by a computer program (described further below) stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, which are executable by the processing device 42. One of ordinary skill in the art would be familiar with the general components of a server system upon which the present invention may be performed. Preferably. It is deployed on a cloud infrastructure, with secure communications with the smart device 20 and parking meter machine 60.

A communication module 44 is responsible for communicating with other devices in the system and routing data to processing device 42. More specifically, it handles incoming traffic in the following cases; (1) initial parking and payment data as input by the user via parking meter machine 60, (2) location updates from smart device 20, (3) mobile payment refill data, and (4) expiration check requests from patrol officers. Outgoing traffic happens in three cases: (1) initial parking data after the user scans the code on the meter card, (2) parking expiration reminder notifications to the smart device 20, and (3) updated user parking time after a recharge payment has been made. A data management module 46 stores and manages parking data related to the user. This includes, for each active user, the starting time of the purchased parking duration, his parking spot number, and the expiration time of the purchased parking duration. It also maintains necessary reference data about the parking lot, such as the coordinate (latitude, longitude) of each parking spot. Other modules access the data stored in the data management module 46 to perform the processes described herein. A notification module 48 retrieves necessary user and application identifiers from data management module 46, and generates and sends reminder messages to the smart device 20.

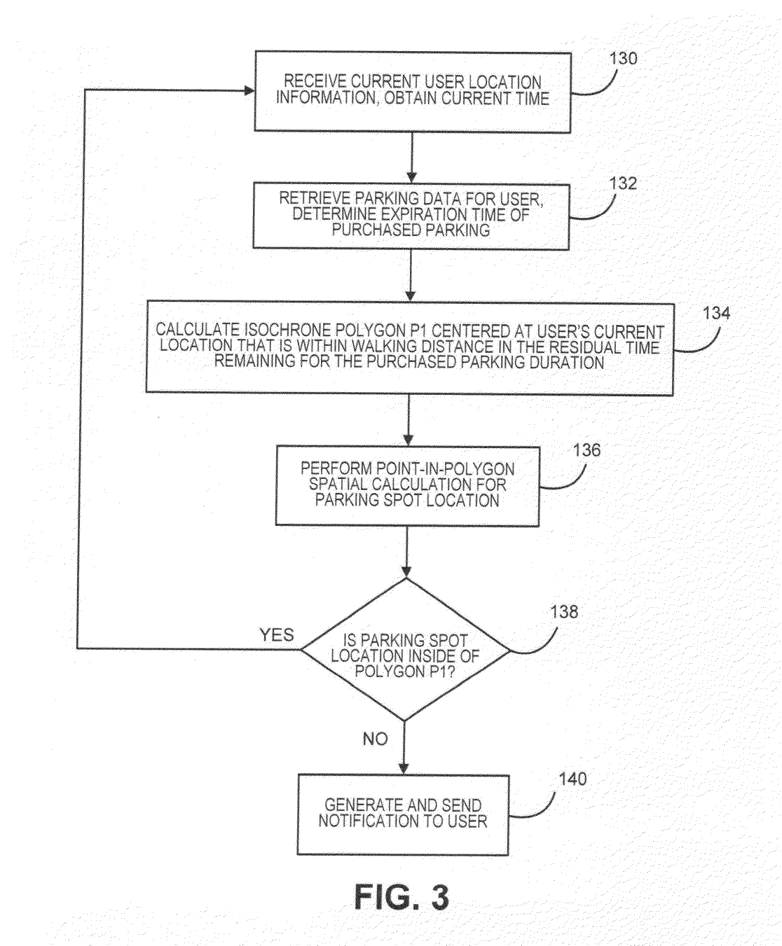

A tracking module 50 uses real-time location tracking streams sent from the location module 28 of the smart device 20 to determine when to send reminder notifications to particular users. More specifically, the decision logic involves obtaining a geometric polygon corresponding to an isochrone from the user's most up-to-date location, and then conducts a Point-in-Polygon spatial calculation using the user's parking spot location (Point geometry, stored in data management module 46 and previously generated isochrone boundary (Polygon geometry) as described further below with respect to FIG. 3). Essentially, isochrone polygon calculation is used to generate the largest geographic area that the user could walk to within the residual time (i.e., expiration time minus current time). Then, a Point-in-Polygon spatial calculation is used to determine whether the user's parking spot location is within the isochrone polygon previously created (i.e., reachable within the residual time constraint). A notification decision is driven by the results of these spatial calculations. Payment module 52 is a counterpart of the payment module 30 of the smart device 20, and processes payments being made by the user.

A parking meter 60 is physically set up in various places of a parking lot, as typically done presently. In many respects the parking meter 60 is similar to known parking meters, especially from the user interface point of view, with a difference that if generates and prints a scannable bar code according to the present invention. Parking meter 60 includes a processing device 62 to control operation of the meter. A user interface which can include, for example, a touchscreen, keypad, or the like, is used to interact with the parking meter 60 to input information, such as, for example, a parking spot number, selected parking duration, and payment information. The processing device 62 of the parking meter 60 is configured to generate a scannable code that is printed by a printer 68. The scannable code could be in any one of various formats, such as 2D bar code, QR code, NFC, etc. The barcode includes parking data including, but not limited to, an identifier for the barcode, and the starting time of the purchased parking, and the amount time purchased for parking. When the user finishes his purchase and instructs the parking meter 60 to print a parking meter card via the user interface 64, this parking data is also transmitted securely to the server 40 using the communication module 26 where if is stored in the data management module 46.

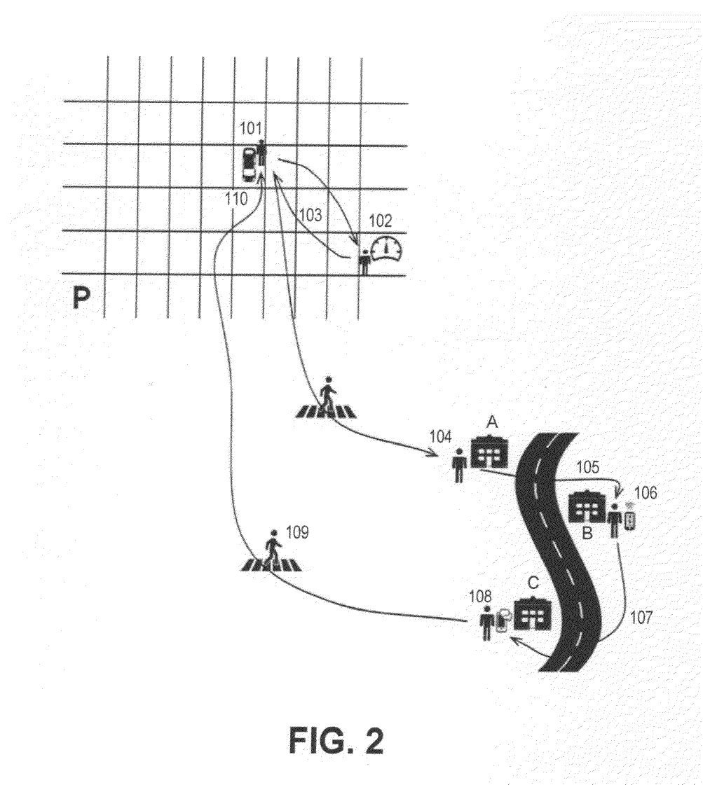

Referring now to FIG. 2, there is illustrated the processing flow of the system of FIG. 1 according to an embodiment of the present invention. At 101, the user arrives at the parking lot. At 102, the user goes to the parking meter 60 and purchases some predetermined number tₚ, e.g., 2 hours, of parking time. The parking meter 60 generates a parking meter card with the following information presented: (1) the starting time of the purchased parking duration tₚ, and (2) a scannable bar code (e.g., QR code) which contains the information as described above. Other information may also be provided on the parking meter card, such as, for example, a parking spot number. Additionally, when the purchase is completed, the parking meter 60 transmits this information to the server 40. At 103, the user returns to his vehicle, and before he places the meter card on the front dash of his vehicle, he scans the bar code using the scanning module 24 of his device 20. The information embodied in the bar code, along with the location of the user's vehicle based on the location of smart device 20 when the scan was performed, is sent to the server 40. The vehicle location (longitude and latitude) is matched with the information previously received (based on the identifier in the barcode) and stored in the data management module 48. Thus, the data management module 46 stores, in association with the barcode identifier, at least the starting time of the purchased parking, the purchased parking duration and the location of the user's vehicle. The location module 28 starts real-time location tracking of the smart device 20, and provides location updates to the server 40. The tracking module 50 of the server 40 will utilize the received location information to determine when to send reminder notifications to the user as will be described further below.

At 104, the user walks to his destination store A, which is a 10 minute walk from his parking spot, and spends 1.5 hours there. At 105, the user walks to another store B, which is a 15 minute walk from his parking spot. As described below with respect to FIG. 3, the tracking module 50 determines, based on the time remaining of the purchased parking duration and the location of the user with respect to the vehicle, when to generate a reminder notification to send to the user's smart device 20 that will allow the user sufficient time to return to the vehicle before expiration of the parking duration. Thus, fifteen minutes before tₚ (when his current parking duration will expire), he receives a notification from the server 40 via his smart device 20, reminding him to get back to his vehicle in order to avoid expiration of the parking meter card. The notification includes two response options: (1) dismiss and start to get back, and (2) a mobile payment option to recharge the meter card. Assuming that the user has other unfinished activities, he decides not to return right away. At 108 he chooses instead to refill the parking meter card and pay for an extra hour of parking time, thus extending the expiration time from tₚ to tᵣ. The user inputs information using the payment module 30 of smart device 20, which communicates with payment module 52 of server 40 to extend the parking duration to tᵣ. The data stored by the data management module 48 is updated to reflect the extended parking duration time.

At 107, the user finishes his visit to store B and moves on to store C, which is a 20 minute walk to where he parked. At any point during the process, a parking enforcement agent could check the user's parking meter card in his vehicle to determine if it has expired or not. This is accomplished by scanning the barcode on the meter card placed in the front dash using a scanning mobile application, and sending the scanned information to the server 40. The server 40 will respond to the device used by the parking enforcement agent to scan the meter card with the current duration for the parking meter card. Thus, if the check is being performed after the user extended his parking duration time, the current duration for the parking meter card is tᵣ, which is 2 hours. The parking enforcement agent can then compare the duration of the parking meter card with the start time printed on the meter card to determine if the parking meter card is still valid. Because the user already extended his parking duration from tₚ to tᵣ, the meter card, at the time of the scan by the parking enforcement agent, was still valid. At 108, twenty minutes before tᵣ, a new notification is sent to the user's smart device 20, reminding him to gel back in order to avoid parking expiration. Since the user has already finished all his activities, he chooses to dismiss the reminder and at 109 heads back to his vehicle. Twenty minutes later, the user returns to his parking spot at 110 and drives away, just in time before the purchased parking duration runs out.

Optionally, at some other later time tₒ (tₒ>tᵣ) if the driver is detected to be out of the boundary of the parking lot, the background service on the driver's smart device 20 will stop location tracking and stop sending location updates to the server 40 in order to save battery.

FIG. 3 illustrates in flow diagram form the operation of the tracking module 50 of the server 40 to determine when a notification should be sent to a user. In step 130, the server 40 receives the current location information for the user (Latitude₁, Longitude₁) that the location module 28 of the user's smart device 20 sends via the communication module 26. Also provided is the barcode identification number for the user's current parking meter card to identify the user to the server 40. Such updates can be sent periodically, such as, for example, every thirty seconds, every minute, or any other period so desired. Also in step 130, the server 40 obtains the current time t₁, using for example, a real time clock that may be provided by the processing device 42. In step 132, the tracking module 50 uses the received barcode identifier to retrieve the parking data that is stored in the data management module 46, which includes the location of the user's vehicle (Latitude₂, Longitude₂), and the starting time of the purchased parking, and the duration of the purchased parking. The tracking module 50 then determines the expiration time t₂ for the duration of purchased parking time (based on the starting time of the purchased parking duration and the amount of time purchased (as may have been updated by the user). Thus, for example, if the starting time was 1:30 pm, and the user purchased 1 hour and then extended if for another hour, the expiration time t₂ would be 3:30 pm. Also in step 132, the tracking module 50 determines the residual time remaining for the purchased parking duration (the difference between the expiration time and the real time, i.e., t₂−t₁).

In step 134, the tracking module 50 calculates an isochrone polygon P1 centered at the user's current location (Latitude₁, Longitude₁) that is within walking distance in the residual time remaining for the purchased parking duration. Essentially, isochrone polygon calculation is used to generate the largest geographic area that the user could walk to within the residual time (i.e., expiration time minus current time) left before the parking meter card will expire. Such calculation can be performed using, for example, an average walking speed of between 2 and 4 mph. In step 136, a point-in-polygon spatial calculation is performed by the tracking module 50 using (Latitude₂, Longitude₂) to determine the current point location on a map of the user's parking spot location. In step 138, it is determined if the point-in-polygon of the user's parking spot is within the calculated polygon P1. If the user's parking spot location is within the polygon P1, then this means that the user still has sufficient time remaining to return to his vehicle, and no reminder notification needs to be sent. The processing returns to step 130 for receipt of the user's current location information and the processing repeats. If the user's parking spot location is not within the polygon P1, then this means that the user must start to return to his vehicle (or add additional time to his purchased parking duration) to avoid returning to the parking spot after the parking meter card has expired. In step 140 the notification module 48 generates and sends a message to the user's smart device 20 (using the communication module 44) that informs the user that he must start returning to his vehicle to avoid returning after the expiration of his purchased parting duration. Optionally, the notification can also allow the user to purchase additional parking time.

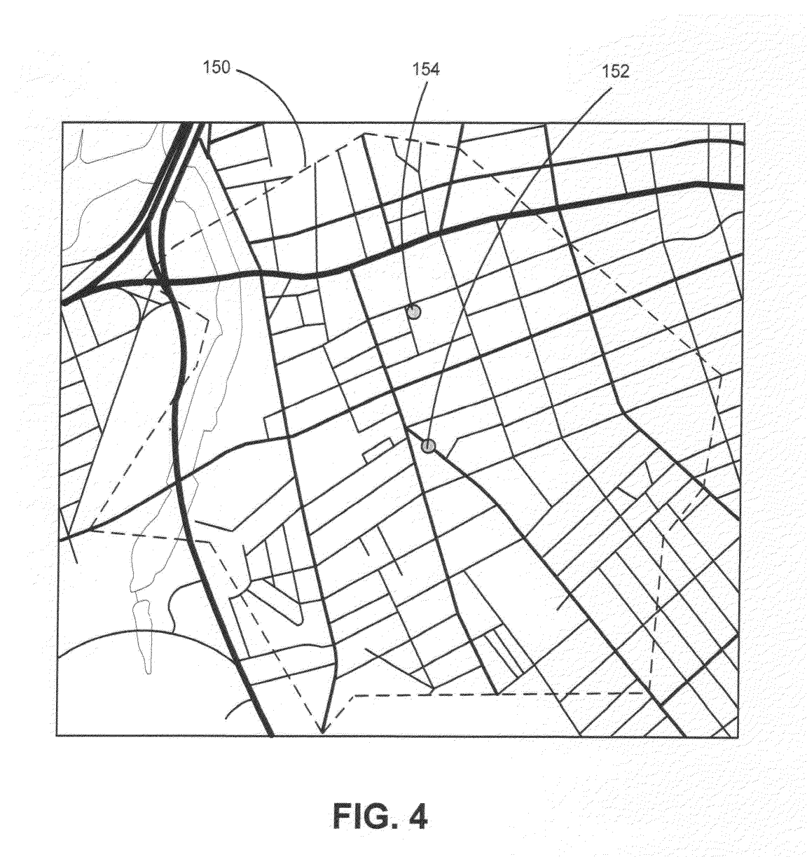

FIG. 4 illustrates an example of a 15-minute isochrone polygon P1 (denoted by boundary line 150) that is centered around a user's current location 152. Thus, the user can walk anywhere within that polygon P1 from his current location within 15 minutes. As shown in FIG. 4, the user's parking spot location 154 is within the polygon P1 (a yes result in step 138 of FIG. 3), and therefore in this condition no notification would be sent to the user. As the residual time decreases, the area of the polygon P1 will decrease, as the user will not be able to walk as far in the time period before expiration of the parking meter card.

In accordance with other embodiments of the present invention, the parking meter 60 need not be as described above or even provided as part of the present invention. Instead the parking expiration notification can be performed using only the smart device 20 and server 40. In this embodiment, the user can still be sent parking reminder notifications when using other types of parking meters, e.g., coin operated meters, that do not have the capabilities of parking meter 60 and are not in communication with the server 40. When the user parks his vehicle, he provides information to the server 40, via the smart device 20, which indicates the amount of parking time purchased and the starting time of the purchased parking. This information is stored by the server 40 in association with an identifier for the user. The user's smart device 20 provides the location of the vehicle to the server 40, and then provides the updates to the server 40 on the user's current location. The server 40 performs functions as described above to determine when to send a reminder notification to the user that informs the user that he must start returning to his vehicle to avoid arriving after the expiration of his purchased parking duration.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method tor a server to provide a parking expiration reminder notification to a user composing:
receiving, by the server, a current location of the user;
retrieving, by the server, parking data for the user the parking data including a location of the user's parked vehicle, a starting time when the user parked the vehicle, and an amount of parking time purchased by the user for the vehicle;
determining, by the server, an expiration time for the parking time purchased by the user and a residual amount of time remaining for the parking time purchased by the user for the vehicle;
calculating, by the server, an isochrone polygon centered around the user's current location that is within walking distance in the residual amount of time remaining for the parking time purchased by the user for the vehicle;
determining, by the server, if the location of the user's vehicle is within the calculated isochrone polygon;
if the location of the user's vehicle is not within the calculated isochrone polygon, generating, by the server, a parking expiration reminder notification for the user; and
sending, by the server, the parking expiration reminder notification to a device associated with the user.

2. The method of claim 1, wherein determining if the location of the user's vehicle is within the calculated isochrone polygon further comprises:
performing, by the server, a point-in-polygon spatial calculation for the location of the user's parked vehicle.

3. The method of claim 1, wherein the parking expiration reminder notification informs the user to start to return to the location of the parked vehicle to arrive before the expiration time for the parking purchased by the user.

4. The method of claim 3, wherein the parking expiration reminder notification further includes an option to purchase additional parking time and extend the expiration time for the parking purchased by the user.

5. The method of claim 1, further comprising:
receiving, by the server, payment information from the user to increase the amount of parking time purchased by the user; and
updating the amount of parking time purchased by the user based on the received payment information.

6. A system to provide a parking expiration reminder notification to a user, the system comprising:
a server including a processing device; and
a memory device storing instructions that when executed by the processing device, cause the server to execute instructions including:
retrieving parking data for the user, the parking data including a location of the user's parked vehicle, a starting time when the user parked the vehicle, and an amount of parking time purchased by the user for the vehicle;
determining an expiration time for the parking time purchased by the user and a residual amount of time remaining for the parking time purchased by the user for the vehicle;
calculating an isochrone polygon centered around a current location of the user that is within walking distance in the residual amount of time remaining for the parking time purchased by the user for the vehicle;
determining if the location of the user's vehicle is within the calculated isochrone polygon;
if the location of the user's vehicle is not within the calculated isochrone polygon, generating a parking expiration reminder notification for the user; and
sending the parking expiration reminder notification to a device associated with the user.

7. The system of claim 6, wherein determining if the location of the user's vehicle is within the calculated isochrone polygon further comprises:
performing a point-in-polygon spatial calculation for the location of the user's parked vehicle.

8. The system of claim 8, wherein the parking expiration reminder notification informs the user to start to return to the location of the parked vehicle to arrive before the expiration time for the parking purchased by the user.

9. The system of claim 8, wherein the parking expiration reminder notification further includes an option to purchase additional parking time and extend the expiration time for the parking purchased by the user.

10. The system of claim 6, wherein the server further executes instructions including:
updating the amount of parking time purchased by the user based on payment information received from the user.
